(19) United States
(12) Patent Application Publication
(10) Pub. No.: US 2013/0177782 A1
(43) Pub. Date: Jul. 11, 2013

(54) BATTERY SAFETY JIG

(71) Applicant: Samuel Beresford Artley, Palm Bay, FL (US)

(72) Inventor: Samuel Beresford Artley, Palm Bay, FL (US)

(21) Appl. No.: 13/738,978

(22) Filed: Jan. 10, 2013

Related U.S. Application Data
(60) Provisional application No. 61/585,520, filed on Jan. 11, 2012.

(51) Int. Cl. H01M 2/34

(52) U.S. Cl. CPC H01M 2/342
USPC 429/1

(57) ABSTRACT

A battery safety jig prevents a user from connecting battery lead terminals on incorrect posts of a battery. The positive and negative posts of the battery can be surrounded by connector jigs. The connector jigs provides an inner shape into which the battery post is disposed. Plate conductors, attached to battery lead terminals, can fit into the inner shapes defined by the connector jigs and attach to the battery posts. The inner shapes can be designed such that the positive plate conductor cannot fit into the negative connector jig and that the negative plate conductor cannot fit into the positive connector jig, thereby eliminating the possibility that the battery lead terminals would be connected to the improper battery post.

### CROSS-REFERENCE TO RELATED APPLICATION

This application claims the benefit of priority of U.S. provisional application No. 61/585,520, filed Jan. 11, 2012, the contents of which are herein incorporated by reference.

### BACKGROUND OF THE INVENTION

The present invention relates to battery accessories and, more particularly, to a jig designed to be permanently attached by a chemical adhesive or mechanical means to a battery terminal, solar battery or non-solar batteries to eliminate the problem of battery terminal mix-up.

Batteries, such as lead-acid batteries, gel batteries. Solar batteries, and the like, supply direct current via terminals disposed on an outer surface of the battery. These terminals are often labeled with a “+” and a “−” to determine the positive and negative terminals, respectively. The labels are often formed in the surface of the battery, typically with raised material. This raised material is often the same color as the battery housing and, therefore, can be difficult to read.

Users, especially non-technical users, can mix up the terminals. With the current method of attaching wires to terminals of a battery, a user can cross-connect the positive terminal to the negative terminal and the negative terminal to the positive terminal. This can result in damage to equipment, to the battery or to other components of a power system.

As can be seen, there is a need for a system to prevent improper wire connections to battery terminals.

### SUMMARY OF THE INVENTION

In one aspect of the present invention, a battery safety jig comprises a positive connector jig surrounding a positive post of a battery with a first defined inner shape; a negative connector jig surrounding a negative post of the battery with a second defined inner shape; a positive plate conductor fitting into the first defined inner shape and electrically connecting to the positive post; and a negative plate conductor fitting into the second defined inner shape and electrically connecting to the negative post, wherein the positive plate conductor is prevented from fitting into the second defined inner shape of the negative connector jig; and the negative plate conductor is prevented from fitting into the first defined inner shape of the positive connector jig.

In another aspect of the present invention, a battery safety jig comprises a non-conductive positive connector jig surrounding a positive post of a battery with a first defined inner shape; a non-conductive negative connector jig surrounding a negative post of the battery with a second defined inner shape; a positive plate conductor fitting into the first defined inner shape and electrically connecting to the positive post; a negative plate conductor fitting into the second defined inner shape and electrically connecting to the negative post; a positive battery lead terminal attached to the positive plate conductor; and a negative battery lead terminal attached to the negative plate conductor, wherein the positive plate conductor is prevented from fitting into the second defined inner shape of the negative connector jig; and the negative plate conductor is prevented from fitting into the first defined inner shape of the positive connector jig.

These and other features, aspects and advantages of the present invention will become better understood with reference to the following drawings, description and claims.

### BRIEF DESCRIPTION OF THE DRAWINGS

FIG. 1 is a perspective view of a battery having a battery safety jig according to an exemplary embodiment of the present invention;

FIG. 2 is a top view of the battery and battery safety jig of FIG. 1; and

FIG. 3 is an exploded perspective view of the battery and battery safety jig of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a battery safety jig that prevents a user from connecting battery lead terminals on incorrect posts of a battery. The positive and negative posts of the battery can be surrounded by connector jigs. The connector jigs provides an inner shape into which the battery post is disposed. Plate conductors, attached to battery lead terminals, can fit into the inner shapes defined by the connector jigs and attach to the battery posts. The inner shapes can be designed such that the positive plate conductor cannot fit into the negative connector jig and that the negative plate conductor cannot fit into the positive connector jig, thereby eliminating the possibility that the battery lead terminals would be connected to the improper battery post.

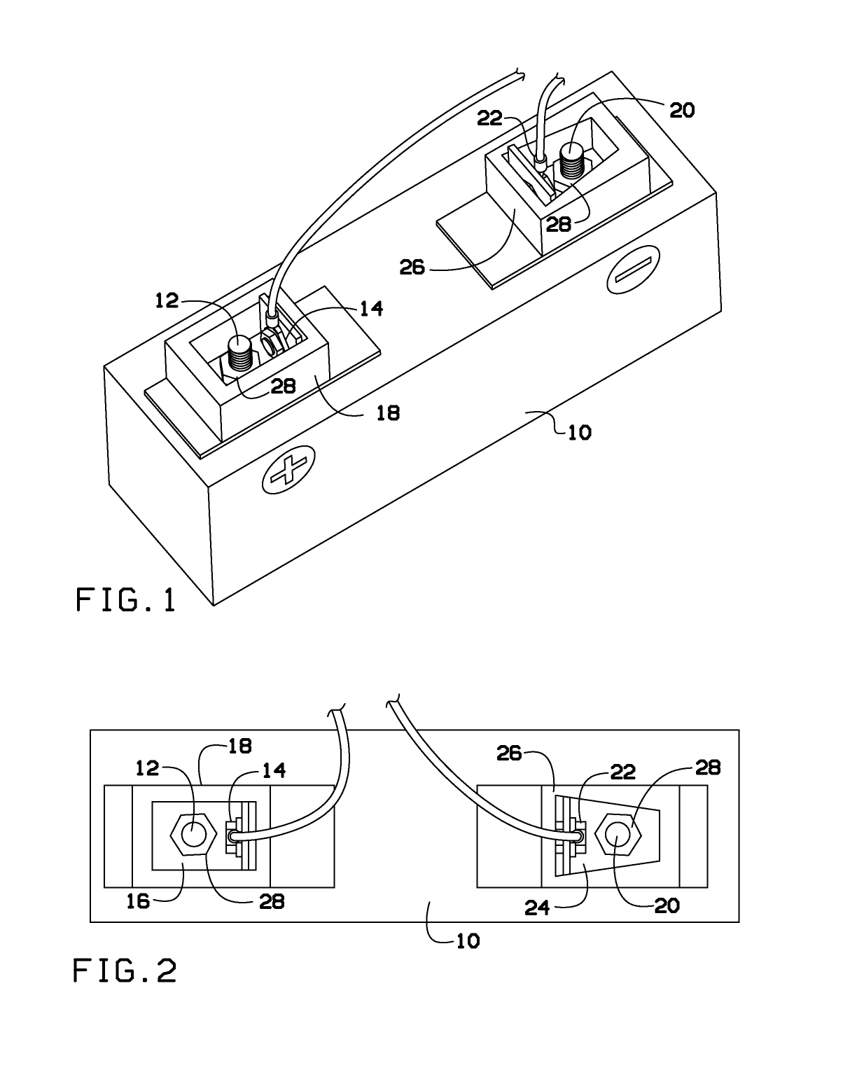

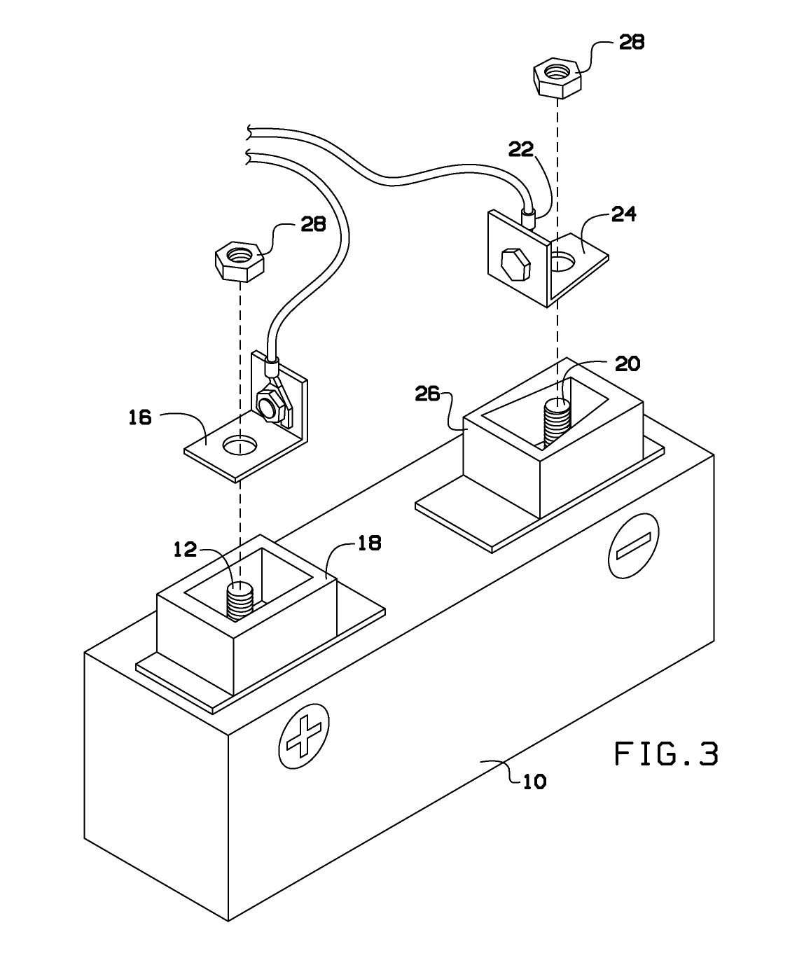

Referring now to FIGS. 1 through 3, a battery 10 can include a positive post 12 and a negative post 20. A positive connector jig 18 can extend from the battery 10 and surround the positive post 12 with a first defined inner shape. A negative connector jig 26 can extend from the battery 10 and surround the negative post 20 with a second defined inner shape. Typically, the positive connector jig 18 and the negative connector jig 26 can be formed of a non-conductive material, such as plastic.

A positive battery lead terminal 14 can attach to a positive metal plate conductor 16. The positive metal plate conductor 16 can be secured to the positive post 12 with a nut 28. The positive metal plate conductor 16 can be sized to fit into the first defined inner shape of the positive connector jig 18, but not fit into the second defined inner shape of the negative connector jig 26. Similarly, a negative battery lead terminal 22 can attach to a negative metal plate conductor 24. The negative metal plate conductor 24 can be secured to the negative post 12 with a nut 28. The negative metal plate conductor 16 can be sized to fit into the second defined inner shape of the negative connector jig 26, but not fit into the first defined inner shape of the positive connector jig 18.

The specific shapes of the jigs 18, 26 and the plate conductors 16, 24 can provide a simply solution that eliminates the possibility of connecting battery lead terminals to the improper terminals. This can help prevent battery damage and system damage.

In some embodiments, the connector jigs 18, 26 can be formed integrally with the housing of the battery 10. In other embodiments, for example, in a retrofit configuration, the connector jigs 18, 26 can be attached to the battery housing with an adhesive, such as an epoxy.

The battery safety jig of the present invention can be used on various batteries in various applications. For example, the battery safety jig of the present invention can be used for automotive, solar power systems, boats, or anywhere needing a battery.

It should be understood, of course, that the foregoing relates to exemplary embodiments of the invention and that modifications may be made without departing from the spirit and scope of the invention as set forth in the following claims.

What is claimed is:

1. A battery safety jig comprising:
a positive connector jig surrounding a positive post of a battery with a first defined inner shape;
a negative connector jig surrounding a negative post of the battery with a second defined inner shape;
a positive plate conductor fitting into the first defined inner shape and electrically connecting to the positive post; and
a negative plate conductor fitting into the second defined inner shape and electrically connecting to the negative post, wherein
the positive plate conductor is prevented from fitting into the second defined inner shape of the negative connector jig; and
the negative plate conductor is prevented from fitting into the first defined inner shape of the positive connector jig.

2. The battery safety jig of claim 1, further comprising:
a positive battery lead terminal attached to the positive plate conductor; and
a negative battery lead terminal attached to the negative plate conductor.

3. The battery safety jig of claim 1, wherein the negative connector jig and the positive connector jig are formed integrally with the battery.

4. The battery safety jig of claim 1, wherein the negative connector jig and the positive connector jig are attached to the battery with an adhesive.

5. The battery safety jig of claim 1, wherein the negative connector jig and the positive connector jig are made of a non-conducting material.

6. The battery safety jig of claim 5, wherein the non-conducting material is a plastic.

7. A battery safety jig comprising:
a non-conductive positive connector jig surrounding a positive post of a battery with a first defined inner shape;
a non-conductive negative connector jig surrounding a negative post of the battery with a second defined inner shape;
a positive plate conductor fitting into the first defined inner shape and electrically connecting to the positive post;
a negative plate conductor fitting into the second defined inner shape and electrically connecting to the negative post;
a positive battery lead terminal attached to the positive plate conductor; and
a negative battery lead terminal attached to the negative plate conductor, wherein
the positive plate conductor is prevented from fitting into the second defined inner shape of the negative connector jig; and
the negative plate conductor is prevented from fitting into the first defined inner shape of the positive connector jig.

8. The battery safety jig of claim 7, wherein the negative connector jig and the positive connector jig are formed integrally with the battery.

9. The battery safety jig of claim 7, wherein the negative connector jig and the positive connector jig are attached to the battery with an adhesive.

10. The battery safety jig of claim 7, wherein the negative connector jig and the positive connector jig are formed of a plastic.
